(19) United States
(12) Patent Application Publication
(10) Pub. No.: US 2018/0266913 A1
(43) Pub. Date: Sep. 20, 2018

(54) METHOD AND DEVICE FOR TESTING THE INTEGRITY OF A PROTECTIVE GLOVE

(71) Applicant: Honeywell International Inc., Morris Plains, NJ (US)

(72) Inventors: Ataur Rahman, Hyderabad, Andhra Pradesh (IN); Garaga Phani Kumar, Hyderabad, Andhra Pradesh (IN); Mehabube Rabbanee Shaik, Hyderabad, Andhra Pradesh (IN); Antonio Vitucci, Wauconda, IL (US); Alfred Flojo, Chicago, IL (US)

(21) Appl. No.: 15/534,664

(22) PCT Filed: Jan. 8, 2016
(86) PCT No.: PCT/US16/12564

§ 371 Date: Jun. 9, 2017

Related U.S. Application Data
(60) Provisional application No. 62/104,483, filed on Jan. 16, 2015.

(51) Int. Cl. G01M 3/26; G01M 3/02

(52) U.S. Cl. CPC G01M 3/26; G01M 3/027

(57) ABSTRACT

A glove inspection device (20) is provided for testing the integrity of a protective glove (10). The device (20) includes a base (22) having a glove mount feature (24) configured to sealingly receive a cuff (18) of a protective glove (10). A pressure sensor (26) is operably connected to the base (22) and is configured to monitor an internal pressure of a protective glove (10) mounted on the glove mount feature (24). A user interface (28) is operably connected to the pressure sensor (26) to provide a representation of the internal pressure monitored by the pressure sensor (26).

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD

This invention relates to protective gloves and the inspection thereof via air pressurization, and in more particular applications to inspections via air test pursuant to Occupational Safety and Health Administration (OSHA) 1910.137.

### BACKGROUND

It is important that protective gloves such as insulating protective gloves to be inspected for any tears and/or cuts. In this regard, the Occupational Safety and Health Administration (OSHA) has issued a standard, OSHA 1910.137 that provides the requirements for specific types of electrical personal protective equipment, including insulating gloves and air pressurization tests have been devised in order to ensure that the standards of OSHA 1910.137 are being met.

In this regard, it is known to sealingly mount an insulating glove onto a base that carries an air pump and to pressurize the inside of the insulating glove utilizing the air pump and then to manually inspect and check the entire glove for leakages in order to detect tears and cuts with observations including changes in size after the glove is internally pressurized.

One such inspection apparatus is illustrated in FIG. 1 which shows an insulated protective glove 10 sealingly mounted on a base 12, with a cuff 14 of the glove 10 in sealed engagement with the base 12 aided by a strap 16. A bellows pump 18 is attached to an opposite face of the base 12 for internally pressurizing the glove 10. As seen in FIG. 2, the glove 10 is pressurized to an internal pressure P1 where the glove 10 is approximately 1.5 to 1.25 times the normal size, depending upon the particular type of insulating glove, then the glove 10 is observed from an initial time t to a final time t Δt to determine if the pressure P2 at the time t+Δt is approximately the same or is less than the pressure P1, This is determined by a visual inspection to see if the glove 10 is less than 1.5 or less than 1.25 times the normal size, again depending on the type of glove, which indicates that the final internal pressure P2 after the time Δt is less than the initial internal pressure P1.

The above procedure depends heavily on manual inspection and skill, is time consuming, and can be prone to judgmental errors by the inspection personnel. Accordingly, there is always room for improvement.

### SUMMARY

In accordance with one feature of this disclosure, a glove inspection device is provided for testing the integrity of a protective glove. The device includes a base having a glove mount feature configured to sealingly receive a cuff of a protective glove. A pressure sensor is operably connected to the base and configured to monitor an internal pressure of a protective glove mounted on the glove mount feature. A user interface is operably connected to the pressure sensor to provide a representation of the internal pressure monitored by the pressure sensor.

As one feature, the user interface includes a wireless transmitter operably connected to the pressure sensor and configured to transmit a wireless signal representative of the internal pressure.

In one feature, the user interface includes a wireless transceiver, and the wireless transceiver includes the wireless transmitter and a wireless receiver.

According to one feature, the wireless transmitter is configured to transmit the wireless signal according to a Bluetooth protocol.

As one feature, the pressure sensor and the wireless transmitter are mounted in a housing carried on the base.

In one feature, the user interface further includes a visual display carried on a hand-held electronic processing device and operably connected to the pressure sensor via a wireless signal transmitted from the wireless transmitter. The visual display is configured to display a visual indication of the internal pressure monitored by the pressure sensor.

According to one feature, the user interface includes a visual display operably connected to the pressure sensor and configured to display a visual indication of the internal pressure monitored by the pressure sensor.

As one feature, the visual display is carried on the base.

In one feature, the visual display is carried on a hand held electronic processing device and is operably connected to the pressure sensor via a wireless signal.

According to one feature, a micro controller is operably connected to the pressure sensor and the user interface and is configured to process a signal from the pressure sensor representing the internal pressure and to communicate the processed signal to the user interface.

As one feature, the user interface includes a wireless transmitter operably connected to the micro controller and configured to transmit a wireless signal representative of the internal pressure.

In one feature, the user interface includes a visual display carried on the base and operably connected to the micro controller and configured to display a visual indication of the internal pressure monitored by the pressure sensor

According to one feature, the glove mount feature includes a cylindrical shaped wall with at least one annular rib extending radially outwardly from the wall for sealing engagement against an interior side of a cuff of a protective glove.

As one feature, a pump is operably connected to the base and configured to pressurize an interior of a protective glove received on the glove mount feature.

In one feature, the pump is carried on the base.

According to one feature, the base has a pump mount feature facing in a direction opposite from the glove mount feature, and the pump is mounted on the pump mount feature.

As one feature, the pressure sensor is carried on the base.

In one feature, at least a portion of the user interface is carried on the base.

According to one feature, the pressure sensor and at least a portion of the user interface are mounted in a housing carried on the base.

As one feature, the housing is removably attached to the base.

In accordance with one feature of this disclosure, a method of testing the integrity of a protective glove is provided. The method includes the steps of: mounting a protective glove on a base, pressurizing an interior of the protective glove, sensing an internal pressure with the glove after the pressurizing step, and transmitting a signal to a visual display representative of the internal pressure sensed in the sensing step.

As one feature, the transmitting step includes transmitting a wireless signal to a hand-held electronic processing device carrying the visual display.

In one feature, the transmitting step includes transmitting the signal to a visual display carried on the base.

Other features and advantages will become apparent from a review of the entire specification, including the appended claims and drawings.

### BRIEF DESCRIPTION OF THE DRAWINGS

FIG. 1 is an isometric view of a protective glove mounted on an inspection device in a known fashion;

FIG. 2 is a diagrammatic representation of a known inspection procedure utilizing the device of FIG. 1;

FIG. 3 is a somewhat diagrammatic elevational view of a glove inspection device according to this disclosure;

FIG. 4a is an isometric view of an inspection module of the device of FIG. 3;

FIG. 4b is a partially exploded section view taken generally along line 4b-4b in FIG. 4 and showing the indicator module of FIG. 4a together with selected components for mounting the indicator module to the device of FIG. 3;

FIG. 5a is an exploded isometric view of alternate embodiments for selected components of the device of FIG. 3;

FIG. 5b is a side elevational view of the embodiments shown in FIG. 5a;

FIG. 5b is a reduced size, isometric view of the assembled components of FIG. 5a;

FIG. 6 is a block diagram of one embodiment of an indicator module of the device of FIG. 3;

FIG. 7 is a block diagram of another embodiment of an indicator module of the device of FIG. 3;

FIGS. 8a-8c, 9a-9c and 10a-10b are a series of figures illustrating a series of visual display screens that can be provided on a handheld electronic processing device in accordance with this disclosure; and

FIG. 11 is a flow chart illustrating a method of inspection according to this disclosure.

### DETAILED DESCRIPTION

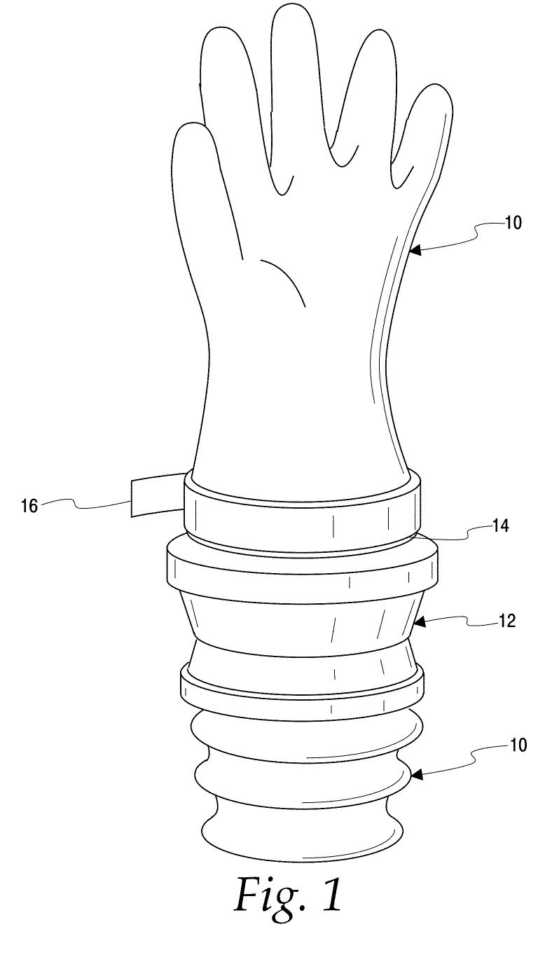

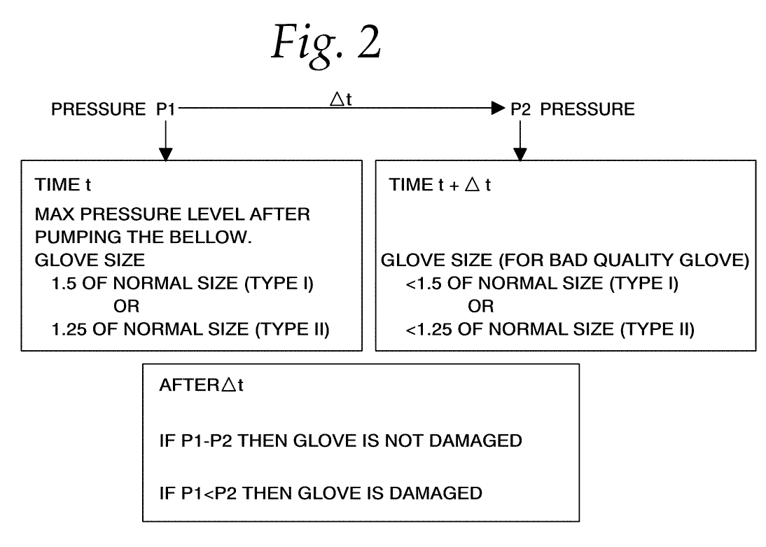

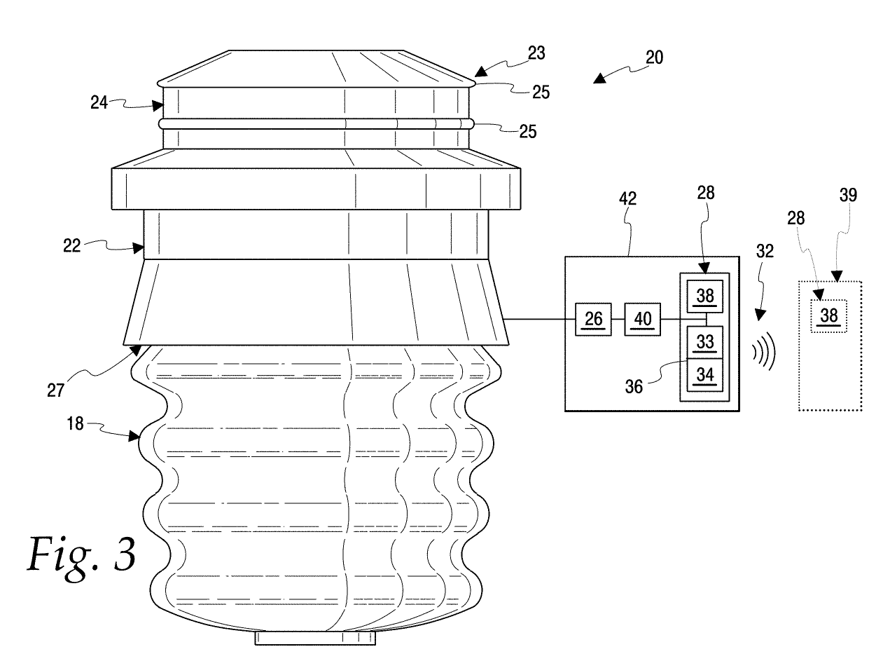

With reference to FIG. 3, a glove inspection device 20 is shown for testing the integrity of a protective glove, such as the protective glove 10 shown in FIG. 1. The device 20 includes a base 22 including a glove mount feature 23 configured to sealingly receive a cuff, such as the cuff 18 of the protective glove 10. In the illustrated embodiment, the glove mount feature 23 includes a cylindrical wall 24 with at least one annular rib 25 extending radially outwardly from the wall 24 for sealing engagement against an interior side of the cuff 18 of the protective glove 10. The device 20 further includes a pressure sensor, shown schematically at 26, operably connected to the base 22 and configured to monitor an internal pressure of a protective glove 10 mounted on the glove mount feature 24, and a user interface, shown schematically at 28, operably connected to the pressure sensor 26 to provide a representation of the internal pressure monitored by the pressure sensor 26.

The device 20 can further include a bellows pump 18 (the same or similar to the bellows pump 18 shown in FIG. 1), with the pump 18 being connected to the base 22 and configured to pressurize an interior of a protective glove 10 received on the glove mount feature 24. In this regard, the base 22 includes a pump mount feature 27 facing in a direction opposite from the glove mount feature 24, with the pump 18 being mounted on the pump mount feature 27 and compressible against any surface that may underlie the device 20 in order to actuate the pump 18 inflate the glove 10. A suitable one-way valve (not shown) may be provided between the pump 18 and the glove 10 to allow air to flow from the pump 18 into the glove 10, but not in the reverse direction.

In some embodiments, the user interface 28 includes a wireless transmitter, shown schematically at 30, operably connected to the pressure sensor 26 and configured to transmit a wireless signal 32 representative of the internal pressure. In some embodiments, it will be desirable for the user interface 28 to include a wireless receiver, shown schematically at 34, with the wireless receiver 34 and the wireless transmitter 30 being part of a wireless transceiver, shown schematically at 36. While the wireless transmitter 30, receiver 34 and transceiver 36 can be configured to operate according to any of the known wireless signal protocols, in many embodiments it will be desirable for the components 30, 34 and 36 to be configured to transmit and receive the wireless signals 32 according to a Bluetooth protocol, such as any of the Bluetooth protocols defined by the Bluetooth Special Interest Group (SIG) and/or any of the additional protocols that have been adopted from other standards bodies (using short-wavelength UHF radio waves in the ISM band from 2.4 to 2.485 GHz).

In some embodiments, the user interface 28 can include a visual display, shown schematically at 38, that is operably connected to the pressure sensor 26 and configured to display a visual indication of the internal pressure monitored by the pressure sensor 26. In some embodiments, as will be discussed further below, the visual display 38 may be included as part of a separate, handheld processing device 39, such as a Smartphone 39, that can communicate with the wireless receiver 34 and/or the wireless transmitter 30 and/or the wireless transceiver 36 via any known wireless signal protocol, which in many embodiments will be a Bluetooth protocol as discussed above. It should be understood that as used herein, the term Smartphone is intended to have its commonly understood meaning, which is a cellular phone that performs many of the functions of a computer, typically having a touch screen interface, internet and/or Cloud access, wireless capabilities, such as local area network capabilities and/or Bluetooth protocol capabilities, and an operating system capable of running downloaded applications. Common conventional examples of Smartphones include iPhones®, Samsung Galaxy® phones, and Motorola Droid® phones.

Many embodiments of the device 20 will further include an electronic processing device, such as a microcontroller shown schematically at 40, that is operably connected to the pressure sensor 26 to receive a signal therefrom indicative of the internal pressure and to process the signal and transmit the processed signal representative of the internal pressure to the user interface 28. In this regard, depending upon the configuration of each particular embodiment, the microcontroller 40, can be connected to any of the components 30, 34, 36 and 38, or all of the components 30, 34, 36 and 38.

In some embodiments, the pressure sensor 26 and any combination of the wireless signal components 30, 34, 36, and the microcontroller 40 can be mounted in a housing, shown schematically at 42, carried on the base 22. Such embodiments may be utilized with an embodiment wherein the visual display 38 is included as part of the separate handheld processing device 39. Other embodiments, can further include a visual display 38 that is also mounted in the housing 42, with some of these embodiments being operable with an additional visual display 38 that is part of a separate handheld processing device 39, and other embodiments not being operable with such a separate handheld processing device 39 and visual display 38 (especially those embodiments that do not include a wireless transmitter 30).

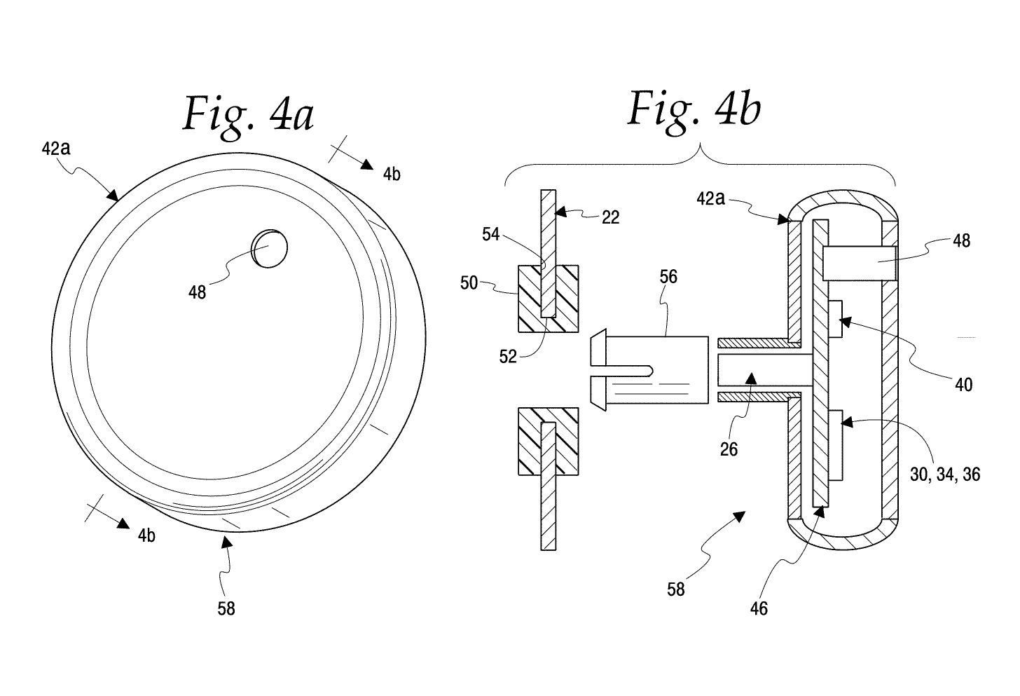

With reference to FIGS. 4a and 4b, an embodiment is shown wherein the components 26, 30, 34, 36 and 40 are mounted in a housing 42a. The components 26, 30-36 and 40 are connected via a circuit board 46, which also carries a light emitting diode 48 that is operably connected to the microcontroller 40 and configured to provide either a color indication or an on/off indication to alert a user that the components 30, 34 and 36 have been successfully paired with a wireless transceiver in another device, such as Smartphone 39 having the visual display 38, via the wireless signals 32, which in the illustrated embodiment are operated according to a Bluetooth protocol. The housing 42a is mounted to the base 22 via a rubber grommet 50 that is received into an opening 52 formed in the base 22 and having an annular groove 54 formed therein for receiving the portion of the housing 42a that surrounds the opening 52. A snap-fit connector 56 is provided for releasably connecting the housing 42a to the grommet 50 and the base 22. Taken together, the housing 42a and the components 26, 30-36, 40 and 48 mounted therein define one embodiment of an indicator module 58.

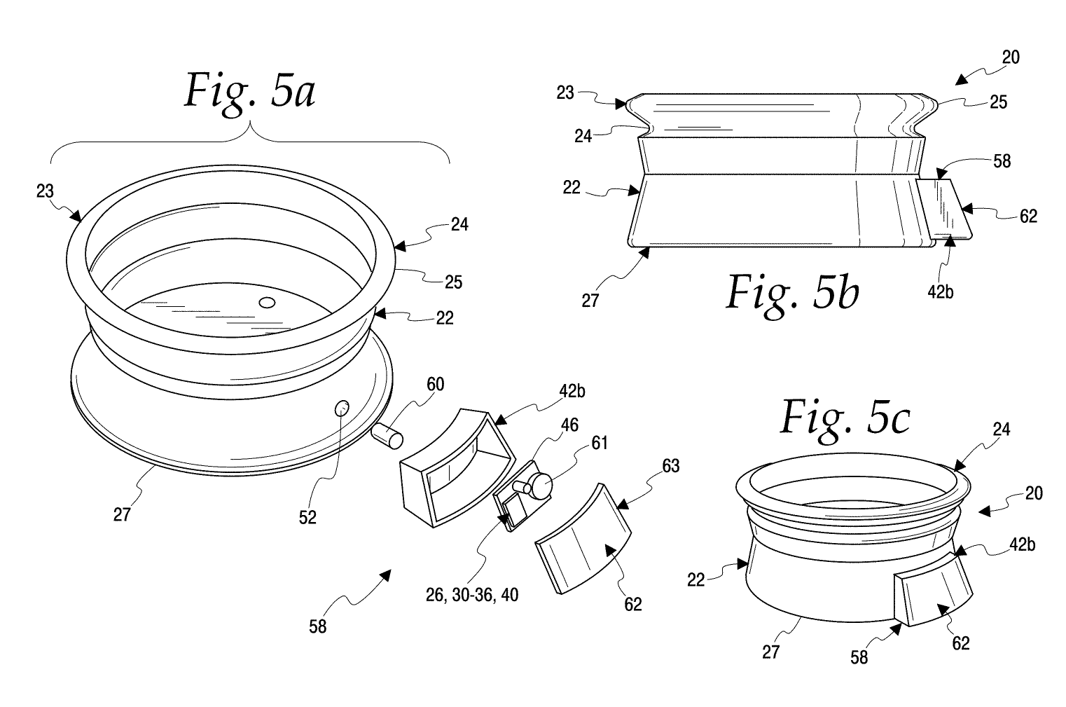

With reference to FIGS. 5a-5c, an embodiment is shown that includes the components 26, 30, 34, 36 and 40, with the components being mounted in a housing 42b that is attached to an opening 52 in the base 22 via a connector 60. A battery 61 is also provided to power the components 26, 30-36 and 40. A similar battery can also be utilized in the embodiment shown in FIGS. 4a-4b. The components 26, 30-36, 40 and 61 are connected via a circuit board 46. Additionally, a visual display 38 is provided in the form of an LCD screen 62 that is part of a cover 63 for closing the housing 42b. The LCD screen 62 is operably connected to the microprocessor 40 to receive signals therefrom. Because this embodiment includes the wireless transmitter 30, receiver 34 and transceiver 36, this embodiment can communicate with a separate handheld processing device 39 having a separate visual display 38 in addition to the display 38 in the housing 42b. Taken together, the housing 42b and the components 26, 30-36, 40, 61 and 62 define another embodiment of an indicator module 58.

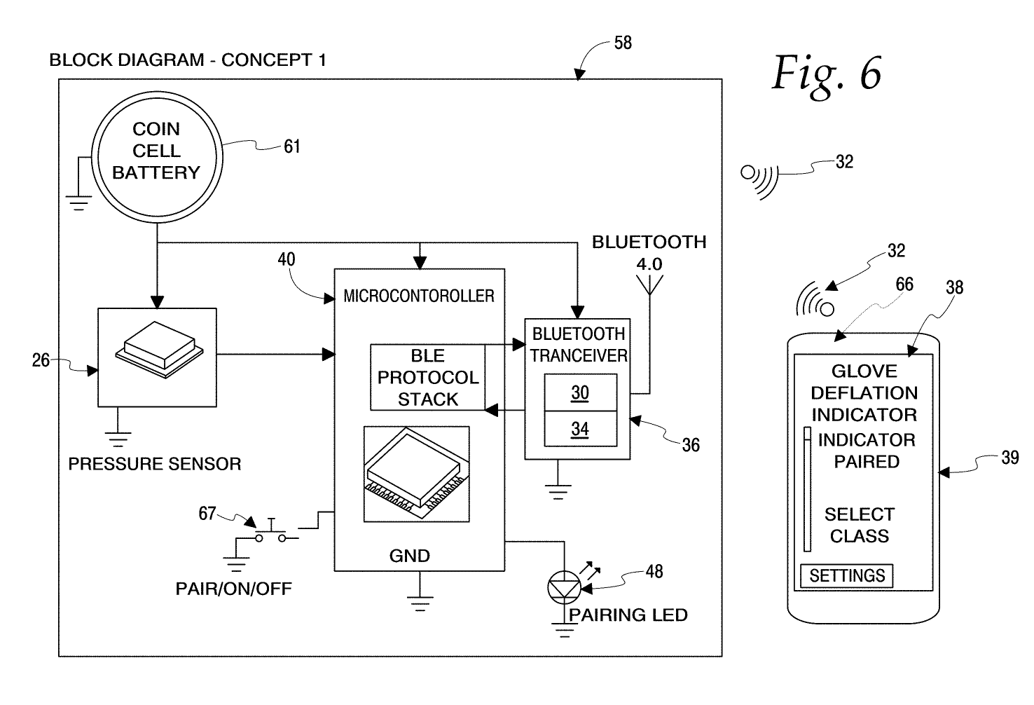

With reference to FIG. 6, a block diagram is shown illustrating the components of an indicator module embodiment 58 such as is shown in FIGS. 4a and 4b. As previously mentioned, the wireless components 30-36 can operably connect to a wireless transceiver 66 of the Smartphone 39 using any suitable wireless signal protocol, which often will be a Bluetooth protocol as previously discussed, with the visual display 38 of the Smartphone 39 being operably connected to the pressure sensor 26 via the wireless signal 32 transmitted from the wireless transmitter 30 and further being configured to provide screen displays that can provide information useful to the person conducting the inspection procedure, such as, for example, an indication that the Smartphone 39 has been paired to the paired (operably connected) wirelessly to the wireless components 30-36 of the indicator module 58, and a visual indication of the internal pressure within a glove 10 during inspection. In this regard, the module 58 can further include a pairing on/off switch 67 for initiating the pairing of the wireless components 30-36 with the transceiver 66 of the Smartphone 39. The pairing LED 48 provides a visual indication when the pairing is successfully completed.

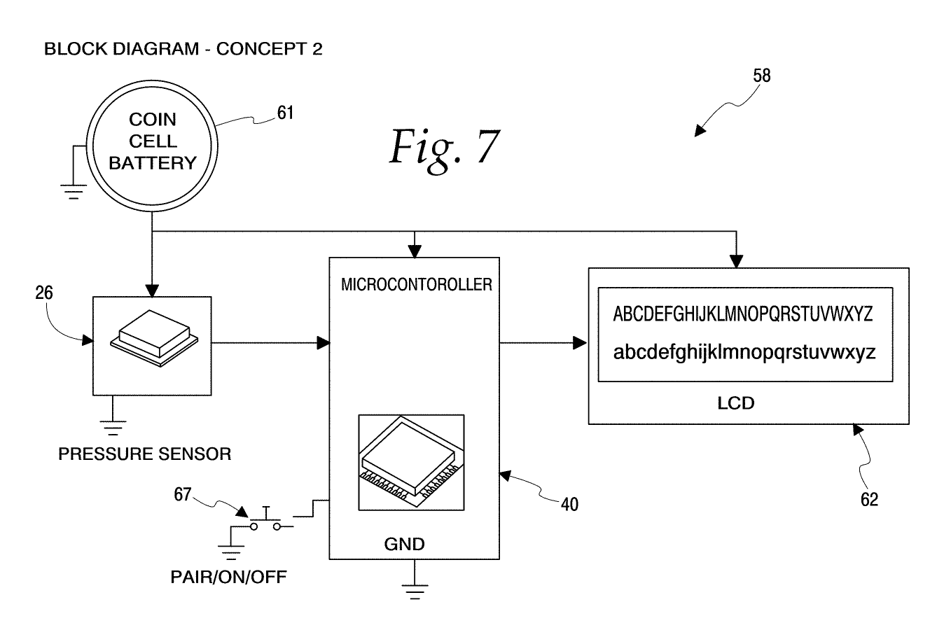

With reference to FIG. 7, a block diagram is shown illustrating the components of an indicator module embodiment 58 similar to the indicator module 58 shown in FIGS. 5a and 5c, with the exception that the embodiment 58 of FIG. 7 does not include any of the wireless signal components 30-36, and instead includes just the LCD 62 as the user interface 28. As seen in FIG. 7, the LCD 62 can be configured to provide information useful to a person conducting the inspection, including any of the information previously discussed herein, such as, for example, the internal pressure within a glove 10 being inspected by the device 20, the elapsed time from when the initial pressure P1 was achieved, the final pressure P2 after the time Δt has passed, and an indication of whether or not the glove 10 has passed or failed the inspection.

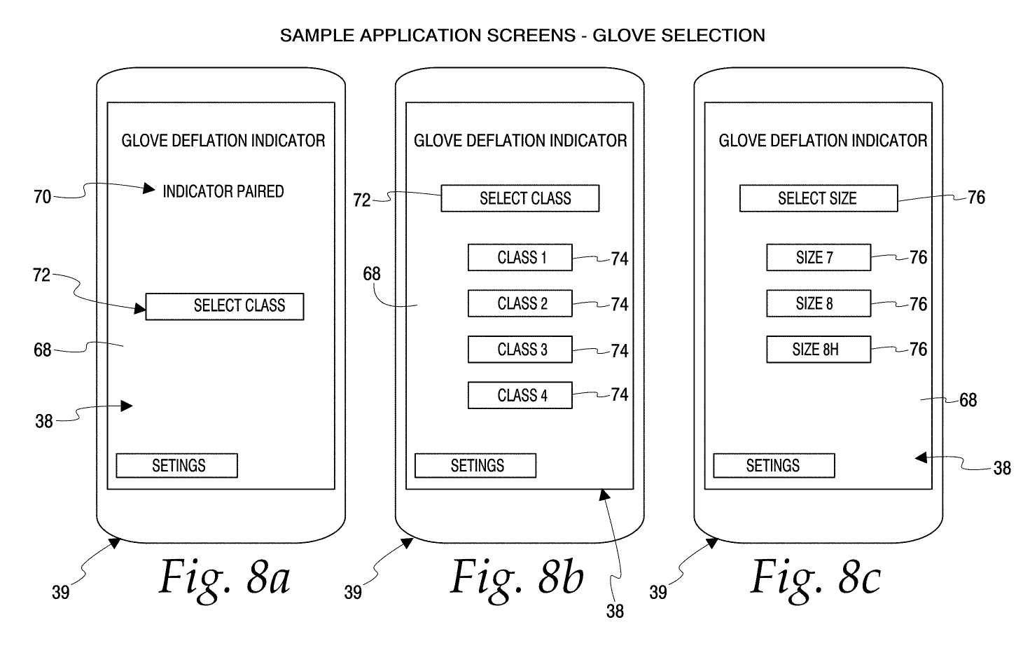

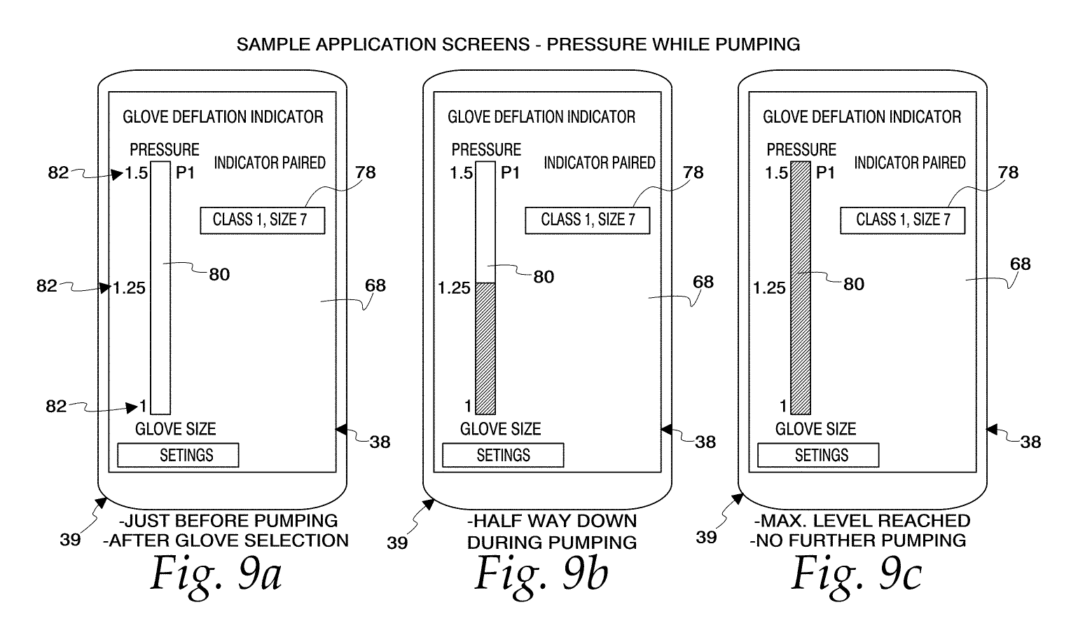

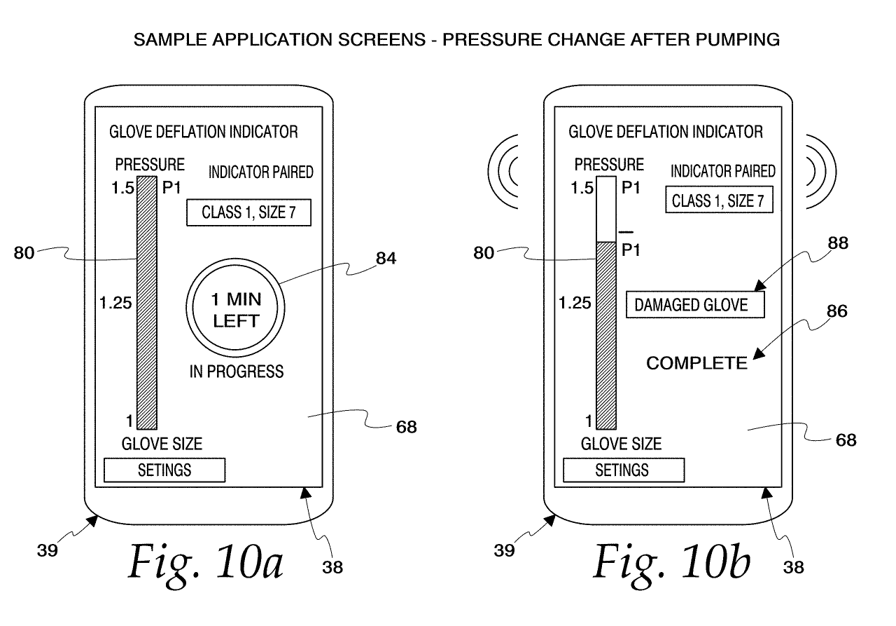

With reference to FIGS. 8a-8c, 9a-9c and 10a-10b, for embodiments that include a handheld electronic processing device 39, such as the Smartphone 39, the Smartphone 39 can be programmed to provide a view screen 68 on the display 38 to provide information for the inspection procedure. For example, the view screen 68 can provide an indication, such as shown at 70 in FIG. 8a, that the Smartphone 39 has been successfully paired with the wireless communication components 30-36, and to allow a user to select an icon 72 that allows for a selection of the specific class of the glove to be inspected, such as shown at 74 in FIG. 8b, and then to further select the size of the glove 10 being inspected, such as shown at 76 in FIG. 8c. In this regard, the Smartphone 39 is configured to calibrate the internal pressure that will correspond to a suggested size change (for example, 1.25 or 1.5) depending upon the class of glove selected and the size of glove selected. In this regard, the Smartphone 39 can further be configured to calibrate the indicator module 58 if required to work for all glove classes and sizes, Next, with references to FIGS. 9a-9b, the screen 68 can provide an indication of the glove class and size have that have been selected for inspection, such as shown at 78, and a pressure indicator, such as shown at 80, to indicate the internal pressure of the glove 10 and to correspond that internal pressure to the expanded size of the glove, such as shown at 82, and then to provide real time feedback as the glove is pressurized, such as shown in FIG. 9b, until the glove is fully pressurized to P1, such as is shown in FIG. 9c. After the glove is fully pressurized to P1, the Smartphone 39 can be programmed/configured so that the screen 68 will indicate the amount of time left to achieve the desired Δt, such as shown at 84 in FIG. 10a and to further indicate when the Δt time has elapsed and the test completed, such as shown at 86 in FIG. 10b, together with an indication of whether or not the glove has passed or failed, such as shown at 88 in FIG. 10b. Typically, the Smartphone 39 can be configured to perform the above operations via downloading a custom application (computer program) onto the Smartphone 39 in order to command the Smartphone 39 to perform the required operations in connection with the indicator module 58.

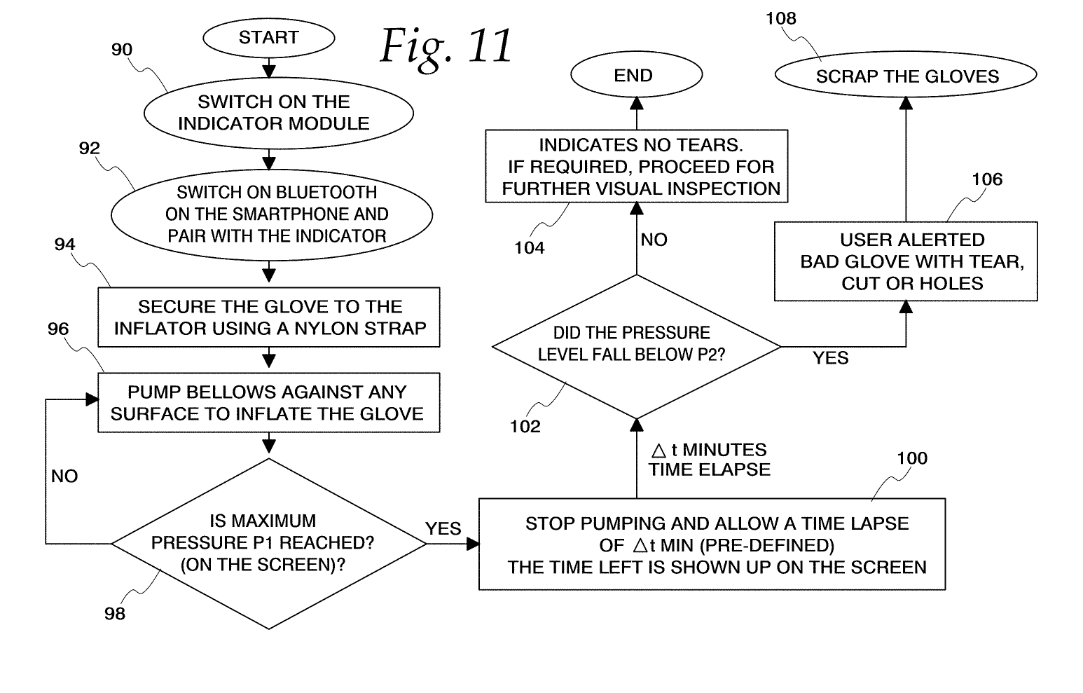

FIG. 11 provides a detailed flow chart for an inspection procedure according to this disclosure. The procedure includes the steps of:
90 switching on the indicator module,
92 pairing the wireless components 30-36 with a Smartphone 39,
94 securing a glove 10 to the base 22,
96 actuating the pump 18 to provide an internal pressure to the glove 10,
98 monitoring that internal pressure to determine if the desired pressure P1 has been reached,
100 terminating the inflation after the pressure P1 has been reached to initiate the time lapse Δt,
102 determining if the internal pressure fell below the desired final pressure P2 after the time Δt has elapsed, to determine if the glove does or does not have tears, holes or cuts based upon the final pressure P2,
104 sending the glove on for further inspection if there are no tears, holes or cuts indicated, or
106 alerting the user that the glove has a tear, cut or hole, and
108 scrapping the glove if it has been determined from the inspection procedure that there are tears, cut or holes in the glove.

It should be understood that while specific embodiments have been shown herein for the device 20, the handheld processing device 39, the indicator modules 58 and the disclosed methods, the disclosure contemplates that modifications can be made within the scope of this disclosure and no limitations are intended unless specifically recited in one of the appended claims.

1. A glove inspection device for testing the integrity of a protective glove, the device comprising:
a base comprising a glove mount feature configured to sealingly receive a cuff of a protective glove;
a pressure sensor operably connected to the base and configured to monitor an internal pressure of a protective glove mounted on the glove mount feature; and
a user interface operably connected to the pressure sensor to provide a representation of the internal pressure monitored by the pressure sensor.

2. The device of claim 1 wherein the user interface comprises a wireless transmitter operably connected to the pressure sensor and configured to transmit a wireless signal representative of the internal pressure.

3. The device of claim 2 wherein the user interface comprises a wireless transceiver, and the wireless transceiver comprises the wireless transmitter and a wireless receiver.

4. The device of claim 2 wherein the wireless transmitter is configured to transmit the wireless signal according to a Bluetooth protocol.

5. The device of claim 2 wherein the pressure sensor and the wireless transmitter are mounted in a housing carried on the base.

6. The device of claim 2 wherein the user interface further comprises a visual display carried on a hand-held electronic processing device and operably connected to the pressure sensor via a wireless signal transmitted from the wireless transmitter, the visual display configured to display a visual indication of the internal pressure monitored by the pressure sensor.

7. The device of claim 1 wherein the user interface comprises a visual display operably connected to the pressure sensor and configured to display a visual indication of the internal pressure monitored by the pressure sensor.

8. The device of claim 7 wherein the visual display is carried on the base.

9. The device of claim 7 wherein the visual display is carried on a hand held electronic processing device and is operably connected to the pressure sensor via a wireless signal.

10. The device of claim 1 wherein a micro controller is operably connected to the pressure sensor and the user interface and is configured to process a signal from the pressure sensor representing the internal pressure and to communicate the processed signal to the user interface.

11. The device of claim 10 wherein the user interface comprises a wireless transmitter operably connected to the micro controller and configured to transmit a wireless signal representative of the internal pressure.

12. The device of claim 10 wherein the user interface comprises a visual display carried on the base and operably connected to the micro controller and configured to display a visual indication of the internal pressure monitored by the pressure sensor.

13. The device of claim 1 wherein the glove mount feature comprises a cylindrical shaped wall with at least one annular rib extending radially outwardly from the wall for sealing engagement against an interior side of a cuff of a protective glove.

14. The device of claim 1 further comprising a pump operably connected to the base and configured to pressurize an interior of a protective glove received on the glove mount feature.

15. The device of claim 13 wherein the pump is carried on the base.

16. The device of claim 15 wherein the base has a pump mount feature facing in a direction opposite from the glove mount feature, and the pump is mounted on the pump mount feature.

17. The device of claim 1 wherein the pressure sensor is carried on the base.

18. The device of claim 1 wherein at least a portion of the user interface is carried on the base.

19. The device of claim 1 wherein the pressure sensor and at least a portion of the user interface are mounted in a housing carried on the base.

20. A method of testing the integrity of a protective glove, the method comprising the steps of:
mounting a protective glove on a base;
pressurizing an interior of the protective glove;
sensing an internal pressure with the glove after the pressurizing step; and
transmitting an electronic signal to a visual display representative of the internal pressure sensed in the sensing step.

21. The method of claim 20 wherein the transmitting step comprises transmitting a wireless signal to a hand-held electronic processing device carrying the visual display.

22. The method of claim 20 wherein the transmitting step comprises transmitting the electronic signal to a visual display carried on the base.
